(19) United States
(12) Patent Application Publication
(10) Pub. No.: US 2016/0350265 A1
(43) Pub. Date: Dec. 1, 2016

(54) PAGE JUMPS BASED ON TEXT HIDING

(71) Applicant: Alibaba Group Holding Limited, Grand Cayman (KY)

(72) Inventors: Yihao HU, Hangzhou (CN); Dafeng Jin, Hangzhou (CN)

(21) Appl. No.: 15/167,616

(22) Filed: May 27, 2016

(30) Foreign Application Priority Data
May 29, 2015 (CN) 201510290556.3

(51) Int. Cl. G06F 17/22; G06F 17/24; G06F 17/21

(52) U.S. Cl. CPC G06F 17/2235; G06F 17/218; G06F 17/24

(57) ABSTRACT

Implementations herein relate to methods and devices for page jumps based on text hiding. A service terminal may tag a jump link using a target invisible string, embed codes corresponding to the target invisible string into codes of text of an original page such that the jump link is invisible when the related page is displayed by a client terminal. When the client terminal executes a page jump, the client terminal may determine a target carrier of the jump link based on the target invisible string in the original page. The service terminal may receive the target carrier and analyze the target carrier to obtain the hidden target jump link referred by the target carrier such that the client terminal may achieve the page jump using the target jump link while prevent the jump link from being copied, modified, and deleted.

### CROSS REFERENCE TO RELATED PATENT APPLICATIONS

This application claims priority to Chinese Patent Application No. 201510290556.3, filed on May 29, 2015, entitled “Method and Devices for Page Jumps Based on Text Hiding,” which is hereby incorporated by reference in its entirety.

### TECHNICAL FIELD

The present application relates to the field of computer technology, and more particularly to a method and a system for page jumps based on text hiding.

### BACKGROUND

With the popularity of mobile communication technology, a mobile terminal (e.g., mobile phones, tablet personal computers (PCs)) may use various types of applications such as a browser, Taobao, Weibo etc. To allow service consumers a quick access to pages implemented by an application, service providers often embed several jump links (e.g., a target URL page) in a relevant page so that the mobile terminal may turn to a target page based on a jump link. For example, a page displayed by a browser may be embedded with information associated with an item sold in Taobao. The mobile terminal may switch from the currently displayed page to the page corresponding to the item.

However, if the above jump link is a visible text displayed directly on the page, the jump link is easily copied, modified or deleted. This affects user experience and causes damages on the service provider.

### SUMMARY

To solve problems of current techniques, the present disclosure provides methods and devices for page jumps based on text hiding. This Summary is not intended to identify all key features or essential features of the claimed subject matter, nor is it intended to be used alone as an aid in determining the scope of the claimed subject matter.

Implementations herein relate to a method for page jumps based on text hiding. The method may be implemented by a service terminal (e.g., a server). The method may include determining a carrier for hiding a jump link and determining a target invisible string as a hidden tag based on a type of the carrier. In implementations, the target invisible string may include a plurality of preset invisible characters of which display widths are zero. The service terminal may embed codes corresponding to the target invisible string into codes of text of an original page.

The service terminal may receive a target carrier from a client terminal, determine a target jump link corresponding to the target carrier based on a preset matching rule, and transmit the target jump link to the client terminal such that the client terminal may load a corresponding target page based on the target jump link. In these instances, the client terminal may determine the target carrier based on the target invisible string carried by the text of the original page.

In implementations, the determining of the target invisible string as the hidden tag based on the type of the carrier may be implemented by the following operations. If the type of the carrier is invisible strings, the service terminal may determine a characteristics string corresponding to the jump link and designate the characteristics string as the target invisible string. If the type of the carrier is visible text, the service terminal may obtain a preset tag string as the target invisible string.

In implementations, the method further includes the following operations. If the type of the carrier is the invisible string, the service terminal may record and store a correlation (e.g., corresponding relationship) between the target invisible string and the jump link as a first matching rule. If the type of the carrier is the visible text, the service terminal may record and store a correlation (e.g., corresponding relationship) between the visible text of the carrier and the jump link as a second matching rule.

In implementations, the determining of the target jump link corresponding to the target carrier based on the preset matching rule may be implemented by the following operations. If the type of the carrier is the invisible string, the service terminal may determine the target jump link based on the first matching rule. If the type of the carrier is visible text, the service terminal may determine the target jump link based on the second matching rule.

The implementations further relate to a method for page jumps. The method may be implemented by a client terminal (e.g., a computing device). The method may include identifying a target invisible string in codes of text of an original page. In implementations, the target invisible string may include a plurality of preset invisible characters of which display widths are zero.

The client terminal may determine a target carrier corresponding to the identified invisible string, and transmit the target carrier to a service terminal such that the service terminal determines a jump link corresponding to the target carrier based on matching rules between jump links and carriers thereof after receiving the target carrier from the client terminal. The client terminal may obtain the target jump link from the service terminal and load the target page corresponding to the target jump link.

In implementations, the determining of the target carrier corresponding to the identified invisible string and transmitting the target carrier to the service terminal may be implemented by the following operations. If the identified invisible string is a characteristics string, the client terminal may transmit the target invisible string as the target carrier to the service terminal such that the service terminal determines the target jump link corresponding to the target invisible string based on a first matching rule between the jump link and a characteristics string.

In implementations, the determining of the target carrier corresponding to the identified invisible string and transmitting of the target carrier to the service terminal may be implemented by the following operations. If the identified target invisible string is a preset tag string, the client terminal may obtain target visible text tagged in the text of the original page and transmit the target visible text as the target carrier to the service terminal such that the service terminal determines the target jump link corresponding to the target visible text based on a second matching rule between the jump link and visible text.

In implementations, the loading of the target page corresponding to the target jump link may be implemented by the following operations. The client terminal may determine whether the target jump link satisfies a domain name rule corresponding to an application running in the foreground. If the target jump satisfies the domain name rule, the client terminal may load the target page corresponding to the target jump link to the application.

The implementations further relate to a device for page jumps based on text hiding. The device may be associated with a service terminal. The device may include a hiding configuration module configured to determine a carrier for hiding a jump link and determine a target invisible string as a hidden tag based on a type of the carrier. In some implementations, the target invisible string may include a plurality of preset invisible characters of which display widths are zero.

The device may further include a coding module configured to embed codes corresponding to the target invisible string into codes of text of an original page. The device may further include an identifying matching module configured to receive a target carrier from a client terminal, determine a target jump link corresponding to the target carrier based on a preset matching rule, and transmit the target jump link to the client terminal such that the client terminal may load a corresponding target page based on the target jump link. In these instances, the client terminal may determine the target carrier based on the target invisible string carried by the text of the original page.

The implementations further relate to a device for page jumps based on text hiding. The device may be associated with a client terminal. The device may include a finding module configured to identify a target invisible string in codes of text of an original page. In some implementations, the target invisible string may include a plurality of preset invisible characters of which display widths are zero.

The device may further include an identifying module configured to determine a target carrier corresponding to the identified invisible string, and transmit the target carrier to a service terminal such that the service terminal determines a jump link corresponding to the target carrier based on a matching rule between the jump link and a carrier thereof after receiving the target carrier from the client terminal.

The device may further include a loading module configured to obtain the target jump link from the service terminal and load the target page to an application corresponding to the target jump link.

As described above, the service terminal may embed codes corresponding to the target invisible string into the codes of the text of text original page via the jump link associated with the target invisible string. Since width of each character of the target invisible string is zero, the character is visible in a coding layer but invisible in a display layer to achieve the hiding purpose.

In implementations, to conduct page jumps, the client terminal may determine a target carrier based on the target invisible string in codes of text of an original page and transmit the target carrier to the service terminal. The service terminal may use an inverse process associated with the hidden jump link to determine a matching rule corresponding to the jump link and further analyze as well as obtain the target jump link corresponding to the target carrier transmitted by the client terminal.

Accordingly, the implementations of the present disclosure may avoid copying, deleting, modifying of jump links of the original page.

Further, the implementations use matching of invisible strings and embedding operations to hide jump links, and therefore are not limited by formats of text and text statements. Since the target invisible string is formed by preset invisible characters, the target invisible string is easily detected such that a jumping operation is performed correctly.

### BRIEF DESCRIPTION OF THE DRAWINGS

The Detailed Description is described with reference to the accompanying figures. The use of the same reference numbers in different figures indicates similar or identical items.

FIG. 1 is a schematic flow diagram illustrating a method for page jumps based on text hiding.

FIG. 2 is a schematic diagram illustrating an example of status of invisible characters in a display layer and a coding layer.

FIG. 3 is a schematic flow diagram illustrating another method for page jumps based on text hiding.

FIG. 4 is a schematic diagram illustrating an example location where a target invisible string is embedded into text of an original page.

FIG. 5 is a schematic flow diagram illustrating yet another method for page jumps based on text hiding.

FIG. 6 is a schematic diagram of an illustrative computing device for page jumps based on text hiding.

FIG. 7 is a schematic diagram of another illustrative computing device for page jumps based on text hiding.

### DETAILED DESCRIPTION

Detailed exemplary implementations are described herein with the accompanying drawings. With respect to the accompanying figures, unless otherwise indicated, the same numerals in different figures denote the same or similar elements. The following exemplary embodiments do not represent all embodiments consistent with the present disclosure.

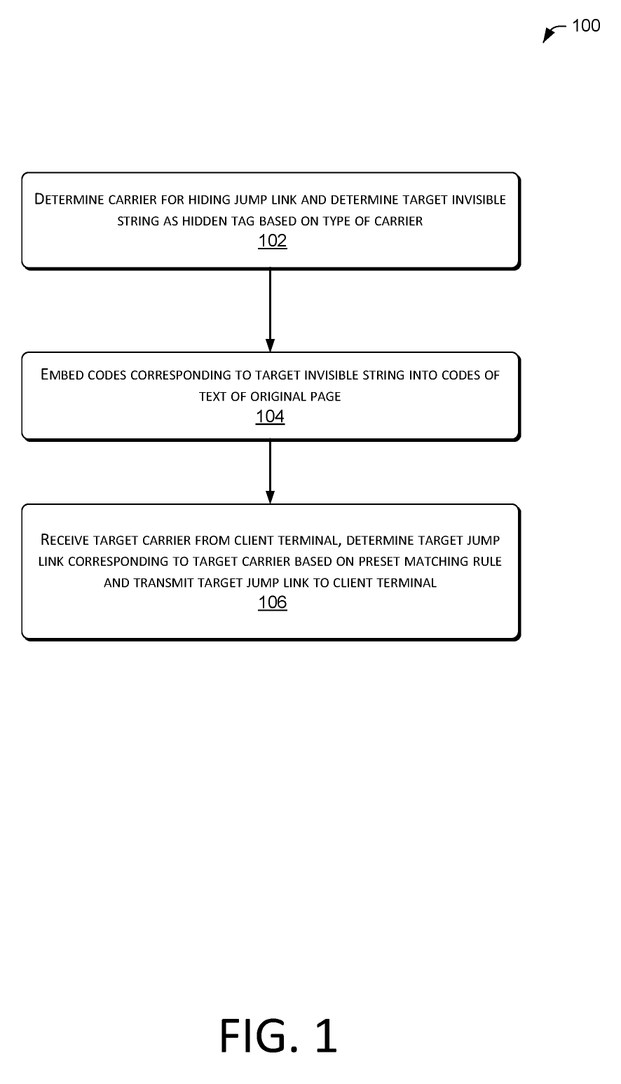

FIG. 1 is a schematic flow diagram illustrating a method for page jumps based on text hiding. The method may be implemented by a service terminal (e.g., a server) such that the service terminal may hide a jump link and assist a client terminal to identify the hidden jump link to display a target page corresponding to the hidden jump link and to avoid copying, deleting, modifying of the jump link.

As illustrated in FIG. 1, the method may include the following operations. At 102, the service terminal may determine a carrier for hiding a jump link and determine a target invisible string as a hidden tag based on a type of the carrier.

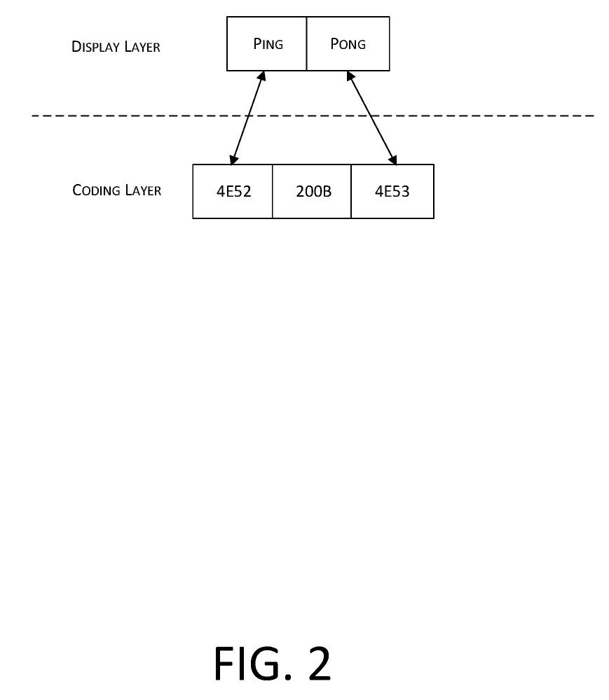

At 104, the service terminal may embed codes corresponding to the target invisible string into codes of text of an original page. The target invisible string is formed by multiple preset invisible characters. Since width of each character of the target invisible string in a display layer is preset to zero, the width of the target invisible string in the display layer is zero. Accordingly, the target invisible string is invisible in the display layer to achieve the hiding purpose. In some implementations, the total number of bits and values of characters of the target invisible string may be set differently, depending on application requirements. For example, in Unicode encoding, four preset invisible characters having width zero may be used, and corresponding codes are: 200B, 200C, 200D and FEFF. FIG. 2 is a schematic diagram illustrating an example of status of invisible characters “200B” of text “Ping Pong” in a display layer and a coding layer.

At 106, the service terminal may receive a target carrier from a client terminal, determine a target jump link corresponding to the target carrier based on a preset matching rule and transmit the target jump link to the client terminal. In these instances, the client terminal may determine the target carrier based on the target invisible string carried by the text of the original page. For example, the service terminal may hide the jump link of the original page in advance as described in 102 and 104, and embed codes of the text of the original page using the target invisible string as a hidden tag such that the jump link is invisible in the display layer to avoid copying and deleting of the original page that is displayed by the client terminal.

Accordingly, after the client terminal loads the original page, if the client terminal needs to visit a page corresponding to the jump link, the client terminal may detect whether the codes of the text of the original page includes the target invisible string. If such target invisible string exists, the client terminal may determine a target carrier based on the target invisible string and transmit the target carrier to the service terminal.

At 106, the service terminal may receive the target carrier from the client terminal, determine the target jump link corresponding to the target carrier, and transmit the target jump link to the client terminal such that the client terminal loads a corresponding target page based on the target jump link.

As described above, the service terminal may embed codes corresponding to a target invisible string into codes of text of an original page using the target invisible string and a jump link. Since width of each character of the target invisible string is zero, the target invisible string is visible in a coding layer but invisible in a display layer to achieve the hiding purpose. In some implementations, to conduct page jumps, the client terminal may determine a target carrier based on a target invisible string in codes of text of an original page and transmit the target carrier to the service terminal.

The service terminal may use an inverse process associated with the hidden jump link to determine a matching rule corresponding to the jump link and further analyze as well as obtain the target jump link corresponding to the target carrier transmitted by the client terminal. Accordingly, the implementations of the present disclosure may avoid copying, deleting, modifying of jump links of the original page.

Further, the implementations use matching of invisible strings and use embedding operations to hide jump links, and therefore are not limited by text formats and text statements. Since the target invisible string is formed by preset invisible characters, the target invisible string is easily detected such that a jumping operation may be performed correctly.

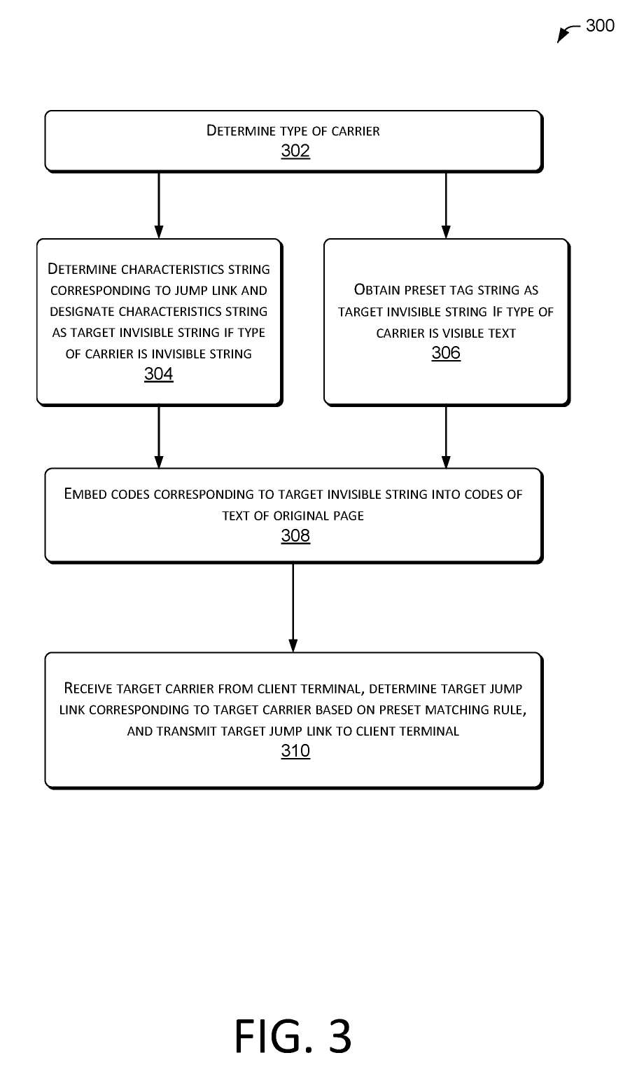

FIG. 3 is a schematic flow diagram illustrating another method for page jumps based on text hiding. In implementations, types of carriers for a jump link may include invisible string(s) and visible text. As illustrated in FIG. 3, the method may include the following operations based on these two types of carriers.

At 302, the service terminal may determine a type of a carrier. If the type is invisible string(s), the service terminal may conduct operation 304. If the type is visible text, the service terminal may conduct operation 306.

In implementations, the service terminal may determine a target carrier using the following methods. If a visible text of an original page includes hidden information (e.g., a specific phrase or short sentence indicating the hidden information), the service terminal may determine that the hidden information includes the visible text as the carrier. If the visible text of the original page does not include the hidden information, the service terminal may determine the target carrier based on a configuration requirement of a service provider or related system. For example, the service provider or related system may define that invisible string(s) is/are preferred to be the target carrier.

At 304, if the type of the carrier is invisible string(s), service terminal may determine a characteristics string corresponding to a jump link and designate the characteristics string as a target invisible string. An invisible string may be a carrier of a jump link. Accordingly, a characteristics string made by multiple preset invisible characters may be used as the carrier of the jump link and a hidden tag with which the client terminal may identify the jump link. In implementations, according to the principle of permutations and combinations, a number of preset invisible characters may form various invisible character strings based on different combinations, and different invisible character strings indicate different jump links.

For example, suppose that the total bits of the characteristics string is 5. In Unicode encoding, four preset invisible characters having width zero may be used, and corresponding codes are: 200B, 200C, 200D, and FEFF. For ease of description, four letters, namely, A, B, C and D, are used to represent the four preset invisible characters. For example, each character of the characteristics string may be any one of A, B, C and D. According to the principle of permutations and combinations, 4⁵ (e.g., 1024) different characteristics strings may be obtained such that 1024 corresponding jump links may be recorded.

At 306, if the type of the carrier is visible text, the service terminal may obtain a preset tag string as the target invisible string. If the visible text is the carrier of the jump link, the text of the original page includes the target visible text corresponding to the jump link. In these instances, the visible text may be used as the carrier of the jump link such that the target invisible string is used to tag the target visible text to allow the client terminal to identify the target visible text. Since the target invisible string itself does not refer to any information, different target visible text are not needed to be differentiated from one another. Accordingly, the service terminal may preset a fixed tag string (e.g., the preset tag string) as a target invisible string in general.

At 308, the service terminal may embed codes corresponding to the target invisible string into the codes of text of the original page. In implementations, if the carrier is the visible text, the target invisible string is the preset tag string. Location(s) where the codes are embedded may be determined based on the target visible text, may include location(s) before and/or after codes of the target visible text. If the codes of the preset tag string are embedded before and after the codes of the target visible text, the client terminal may correctly intercept the corresponding target visible text when identifying the hidden jump link.

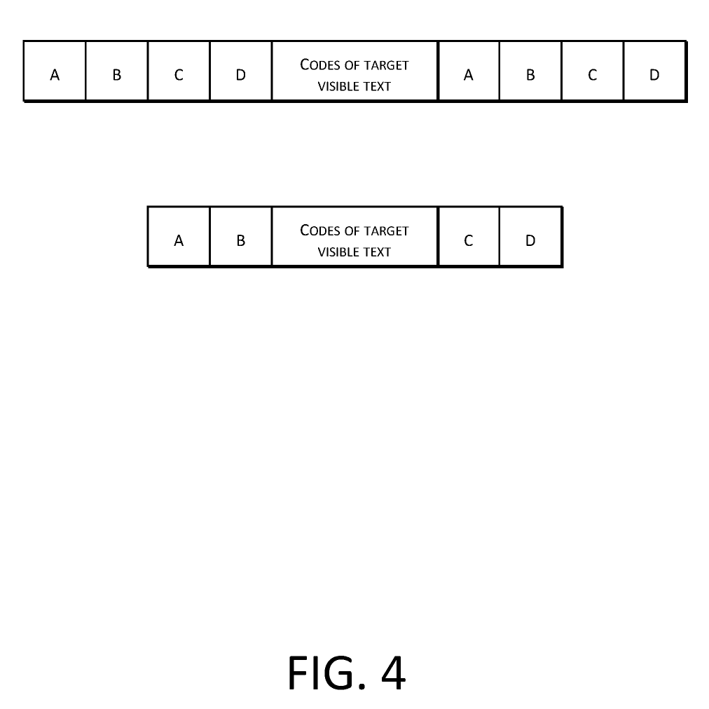

As illustrated in FIG. 4, suppose that the preset tag string is “ABCD.” In some implementations, the “ABCD” may be embedded before and after the codes of the target visible text. Alternatively, “AB” may be embedded before the codes of the target visible text and “CD” may be embedded after the codes of the target visible text.

It should be noted that, if the target carrier is an invisible string, a preset default embedding location may be used (e.g., at the end of the first row of the corresponding paragraph). Alternatively, the service terminal may determine the embedding location based on the visible text related to the corresponding jump link (e.g., after the codes of the related visible text).

At 310, the service terminal may receive the target carrier from the client terminal, determine the target jump link corresponding to the target carrier based on a preset matching rule, and transmit the target jump link to the client terminal.

The preset matching rule indicates a corresponding relationship between a jump link and a carrier. Matching rules may include a first matching rule indicating a correlation (e.g., corresponding relationship) between a characteristics string and a jump link, and a second matching rule indicating a correlation (e.g., corresponding relationship) between visible text and a jump link.

For the first matching rule, in some implementations, the service terminal may preset the first matching rule before performing the hiding operation of the jump link (i.e., before the operation 304). Suppose that a characteristics string (e.g., five characters) include four invisible characters. A part or all of the 1024 characteristics strings may be generated to correspond to the jump link. Accordingly, the first matching rule is illustrated in the table 1. For example, the characteristics string “AAAAA” corresponds to M1 and the characteristics string “BAAAA” corresponds to M2. Accordingly, at 304, the service terminal may determine the characteristics string corresponding to the jump link based on the first matching rule.

Table 1 shows correspondence relationships between characteristics strings and jump links (first matching rule).

| characteristics string | jump link |
|---|---|
| AAAAA | M₁ |
| BAAAA | M₂ |
| . . . | . . . |

In implementations, the first matching rule may be configured after operation 304. In these instances, during operation 304, the service terminal may select a target characteristics string without a corresponding jump link as the target visible string and further perform the following operations.

The service terminal may record and store the jump link to be hidden and the characteristics string selected by operation 304 in a preset data set (e.g., data shown in table 1) associated with the first matching rule.

Similarly, the second matching rule may be configured before operation 306. In implementations, the service terminal may record and store the target visible text as the carrier and a corresponding jump link in a corresponding preset data set to obtain the second matching rule in response to determining that the type of the carrier is visible text.

In implementations, based on the first and second matching rules, the service terminal may determine the target jump corresponding to the target carrier based on the preset matching rule. For example, if the type of the carrier is an invisible string, the service terminal may determine the target jump link based on the first matching rule. If the type of the carrier is visible text, the service terminal may determine the target jump link based on the second matching rule.

The implementations relate to methods for hiding and identifying jump links for various carriers to control page jumps such that the jump links are not copied, modified or deleted and meet different display requirements.

The implementations further relate to computer storage media such as ROM, RAM, CD-ROM, magnetic tapes, floppy disks, and optical data storage devices etc. The computer storage media stores a program, which is executed by one or more processors of the service terminal to enable the service terminal to implement at least a part of the methods for page jumps based on text hiding.

Corresponding to the method implemented by a service terminal, the implementations further relate to a method that is implemented by a client terminal for page jumps based on hidden jump links.

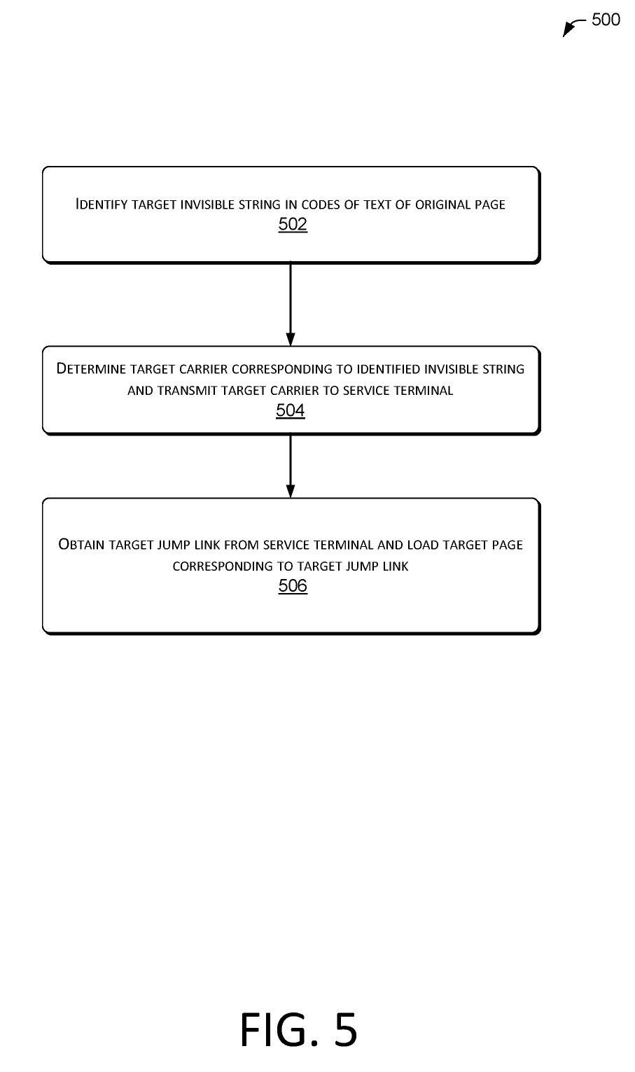

As illustrated in FIG. 5, the method includes the following operations. At 502, the client terminal may identify a target invisible string in codes of text of an original page.

The text of the original page may be page text including the hidden jump link obtained by the operations such as 102, 104 or 302 and 308. In these instances, the target invisible string may include a plurality of preset invisible characters of which display widths are zero.

At 504, the client terminal may determine a target carrier corresponding to the identified invisible string and transmit the target carrier to a service terminal.

Based on operation 504, a service terminal (e.g., a server) receives the target carrier from the client terminal, determine the target jump link corresponding to the target carrier based on a preset matching rule, and transmit the target jump link to the client terminal such that the client terminal may continue to perform operation 506.

At 506, the client terminal may obtain the target jump link from the service terminal and load the target page corresponding to the target jump link.

This method for page jumps based on text hiding may be implemented by the client terminal, which communicates with the service terminal to identify the hidden jump link to avoid copying, modifying, and deletion, for example, of the jump link as compared to a technique that displaya a jump link in visible text.

Further, the implementations use matching of invisible strings and embedding operations to hide jump links, and therefore are not limited by text formats and text statements. Since the target invisible string is formed by preset invisible characters, the target invisible string is easily detected such that a jumping operation is performed correctly.

In implementations, the determining of the target carrier corresponding to the identified invisible string and transmitting of the target carrier to the service terminal as described in 504 may be implemented by the following operations. 1) If the identified invisible string is a characteristics string, this indicates that the target carrier is the characteristics string. In these instances, the client terminal may transmit the target invisible string as the target carrier to the service terminal such that the service terminal determines the target jump link corresponding to the target invisible string based on a first matching rule between the jump link and a characteristics string. 2) if the identified target invisible string is a preset tag string, this indicates that the target carrier is the visible text labeled by the preset tag string. In these instances, the client terminal may obtain target visible text tagged in the text of the original page, and transmit the target visible text as the target carrier to the service terminal such that the service terminal determines the target jump link corresponding to the target visible text based on a second matching rule between the jump link and visible text.

This method for page jumps based on text hiding may be applied to page jumps between different pages implemented by an application (e.g., the original page and the target page belong to the application) or between different pages implemented by different applications (e.g., the original page and the target page belong to different applications).

In implementations, with respect to page jumps between different pages implemented by different applications, at 502, the text of the original page may be read from a system clipboard of the client terminal. For example, the client terminal may perform a selection operation and a copying operation such that the text containing the jump link may be copied to the system clipboard, and perform an analysis operation on the content of the clipboard using operations 502 to 504 to obtain the hidden jump link. The client terminal may further perform the operation 506 after a service consumer switches the preset application.

At 506, the client terminal may load the target page corresponding to the target jump link. For example, the client terminal may determine whether the target jump satisfies the domain name rule. If the target jump satisfies the domain name rule, the client terminal may load the target page corresponding to the target jump link to the application. Through the above domain name-based filtering rule, the application corresponding to the target jump link is loaded with the obtained target page to ensure the service consumer to experience related functions of the target page, for example.

The implementations further relate to computer storage media such as ROM, RAM, CD-ROM, magnetic tapes, floppy disks, and optical data storage devices etc. The computer storage media stores a program, which is executed by one or more processors of the service terminal to enable the client terminal to implement at least a part of the methods for page jumps based on text hiding.

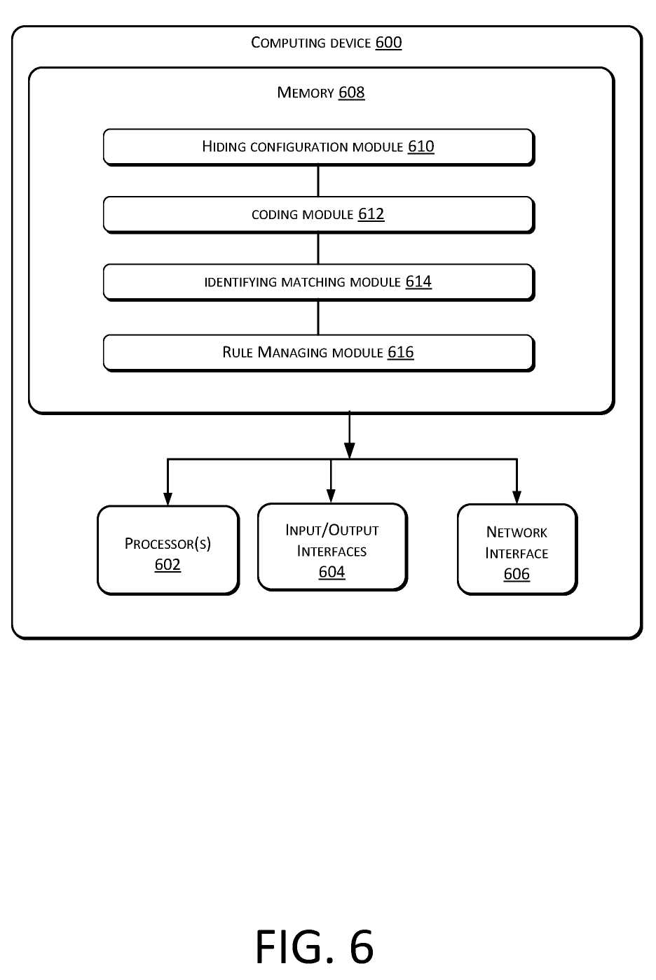

FIG. 6 is a schematic diagram of an illustrative computing device 600 for page jumps. The device may be deployed to a service terminal (e.g., a server) such that the service terminal may hide a jump link and assist a client terminal to identify the hidden jump link to display a target page corresponding to the hidden jump link and to avoid copying, deleting, modifying of the jump link.

The computing device 600 may be a user device or a server for page jumps. In an exemplary configuration, the computing device 600 includes one or more processors 602, input/output interfaces 604, network interface 606, and memory 608.

The memory 608 may include computer-readable media in the form of volatile memory, such as random-access memory (RAM) and/or non-volatile memory, such as read only memory (ROM) or flash RAM. The memory 608 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 608 in more detail, the memory 608 may include a hiding configuration module 610, a coding module 612, and an identifying matching module 614.

The hiding configuration module 610 may be configured to determine a carrier for hiding a jump link and determine a target invisible string as a hidden tag based on a type of the carrier. In these instances, the target invisible string includes a plurality of preset invisible characters of which display widths are zero.

The coding module 612 may be configured to embed codes corresponding to the target invisible string into codes of text of an original page.

The identifying module 614 may be configured to receive the target carrier from the client terminal, determine the target jump link corresponding to the target carrier based on a preset matching rule, and transmit the target jump link to the client terminal. In these instances, the client terminal may determine the target carrier based on the target invisible string carried by the text of the original page.

As described above, the service terminal may embed codes corresponding to a target invisible string into codes of text of an original page via a jump link associated with a target invisible string. Since width of each character of the target invisible string is zero, the target invisible string is visible in a coding layer but invisible in a display layer to achieve the hiding purpose. In some implementations, to conduct page jumps, the client terminal may determine a target carrier based on the target invisible string in codes of text of an original page and transmit the target carrier to the service terminal.

The service terminal may use an inverse process associated with the hidden jump link to determine a matching rule corresponding to the jump link and further analyze as well as obtain the target jump link corresponding to the target carrier transmitted by the client terminal. Accordingly, the implementations of the present disclosure may avoid copying, deleting, modifying of jump links of the original page.

Further, the implementations use matching of invisible strings and use embedding operations to hide jump links, and therefore are not limited by text formats and text statements. Since the target invisible string is formed by preset invisible characters, the target invisible string is easily detected such that a jumping operation is performed correctly.

In implementations, the hiding configuration module 610 may further determine a characteristics string corresponding to the jump link and designating the characteristics string as the target invisible string if the type of the carrier is invisible string(s). If the type of the carrier is visible text, the hiding configuration module 610 may obtain a predetermined tag string as the target invisible string.

In implementations, the memory 608 may further include a rule managing module 616 configured to store a correlation between the target invisible string and the jump link as a first matching rule if the type of the carrier is the invisible string. If the type of the carrier is the visible text, the rule managing module 616 may store a correlation between the visible text of the carrier and the jump link as a second matching rule.

In implementations, the identifying matching module 614 may be configured to determine the target jump link based on the first matching rule if the type of the carrier is the invisible string and determine the target jump link based on the second matching rule if the type of the carrier is visible text.

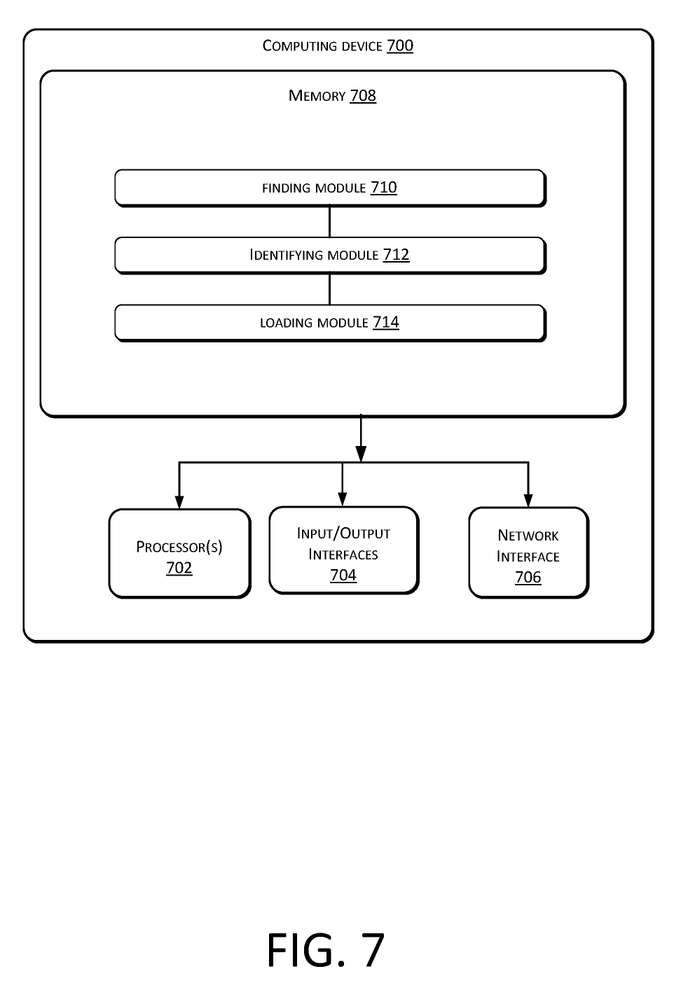

FIG. 7 is a schematic diagram of another illustrative computing device 700 for page jumps. The device may be deployed to a client terminal. The computing device 700 may be a user device or a server for page jumps. In an exemplary configuration, the computing device 700 includes one or more processors 702, input/output interfaces 704, network interface 706, and memory 708.

The memory 708 may include computer-readable media in the form of volatile memory, such as random-access memory (RAM) and/or non-volatile memory, such as read only memory (ROM) or flash RAM. The memory 708 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 708 in more detail, the memory 708 may include a finding module 710, an identifying module 712, and a loading module 714.

The finding module 710 may be configured to identify a target invisible string in codes of text of an original page. In these instances, the target invisible string may include a plurality of preset invisible characters of which display widths are zero.

The identifying module 712 may be configured to determine a target carrier corresponding to the identified invisible string, and transmit the target carrier to the service terminal such that the service terminal determines the jump link corresponding to the target carrier based on a matching rule between the jump link and the target carrier after receiving the target carrier.

The loading module 714 may be configured to obtain the target jump link from the service terminal and load the target page to an application corresponding to the target jump link.

In some implementations, the identifying module 712 may be configured to transmit the target invisible string as the target carrier to the service terminal if the identified invisible string is a characteristics string such that the service terminal determines the target jump link corresponding to the target invisible string based on the first matching rule between the jump link and a characteristics string.

The tagged target visible text may be transmitted to the service terminal as the target carrier such that the service terminal determines the target jump link corresponding to the target visible text based on the second matching rule between the jump link and visible text.

In implementations, the loading module 714 may be configured to determine whether the target jump link satisfies a domain name rule corresponding to an application running in the foreground. If the target jump satisfies the domain name rule, the loading module 714 may load the target page corresponding to the target jump link to the application running in the foreground.

The additional details related to above apparatus implementations may be found in operations described above related to the methods. After consideration of the specification and practice of the present disclosure herein, one skilled in the art may think of other implementations related to the present disclosure. This present disclosure may include variations of the implementations, which include common knowledge or conventional techniques that may not be disclosed in the present disclosure. The specification and examples herein are considered as exemplary only, and a true scope and spirit of the present disclosure are indicated by the following claims.

It should be understood that the present disclosure is not limited to precise structures described and illustrated in the accompanying drawings. These structures may be modified and changed without departing from this present disclosure. The scope of the disclosure includes the scope of the appended claims.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A method implemented by one or more computing devices, the method comprising:
determining a target carrier for hiding a target jump link;
determining a target invisible string as a hidden tag based on a type of the target carrier, the target invisible string comprising a plurality of preset invisible characters of which display widths are zero; and
embedding codes corresponding to the target invisible string into codes of text of an original page.

2. The method of claim 1, further comprising:
receiving the target carrier from a client terminal;
determining the target jump link corresponding to the target carrier based on a preset matching rule; and
transmitting the target jump link to the client terminal to cause the client terminal to load a corresponding target page based on the target jump link, wherein the target invisible string carried by the text of the original page enables the client terminal to determine the target carrier.

3. The method of claim 2, further comprising:
storing a first correlation between the target invisible string and the target jump link as a first matching rule when the type of the carrier is an invisible string type; and
storing a second correlation between a visible text of the carrier and the target jump link as a second matching rule when the type of the carrier is a visible text type.

4. The method of claim 3, wherein determining the target jump link corresponding to the target carrier based on the preset matching rule comprises:
determining the target jump link based on the first matching rule if the type of the carrier is the invisible string type; and
determining the target jump link based on the second matching rule If the type of the carrier is the visible text type.

5. The method of claim 1, wherein determining the target invisible string as the hidden tag based on the type of the carrier comprises determining a characteristics string corresponding to the target jump link and designating the characteristics string as the target invisible string in response to the type of the carrier being an invisible string.

6. The method of claim 1, wherein determining the target invisible string as the hidden tag based on the type of the carrier comprises obtaining a predetermined tag string as the target invisible string in response to the type of the carrier being a visible text.

7. The method of claim 1, wherein embedding the codes corresponding to the target invisible string into the codes of text of the original page comprises embedding a portion or all of the codes corresponding to the target invisible string before and/or after the codes of text of the original page.

8. A method implemented by one or more computing devices, the method comprising:
identifying a target invisible string in codes of text of an original page, the target invisible string comprising a plurality of preset invisible characters;
determining a target carrier corresponding to the identified target invisible string;
transmitting the target carrier to a service terminal to cause the service terminal to determine a target jump link corresponding to the target carrier based on a matching rule between the target jump link and the target carrier;
obtaining the target jump link from the service terminal; and
loading a target page corresponding to the target jump link.

9. The method of claim 8, wherein transmitting the target carrier to the service terminal comprises transmitting the target invisible string as the target carrier to the service terminal in response to determining that the identified invisible string is a characteristics string.

10. The method of claim 8, wherein transmitting the target carrier to the service terminal comprises obtaining target visible text tagged in the text of the original page and transmitting the target visible text as the target carrier to the service terminal in response to determining that the identified target invisible string is a preset tag string.

11. The method of claim 8, wherein loading the target page corresponding to the target jump link comprises:
determining whether the target jump link satisfies a domain name rule corresponding to an application running in a foreground; and
loading the target page corresponding to the target jump link to the application in response to determining that the target jump link satisfies the domain name rule.

12. The method of claim 8, wherein a portion or all of the plurality of preset invisible characters are located before and/or after the codes of the text of the original page.

13. The method of claim 8, wherein the plurality of preset invisible characters have zero display widths.

14. A device comprising:
one or more processors; and
memory to maintain a plurality of components executable by the one or more processors, the plurality of components comprising:
a hiding configuration module configured to:
determine a target carrier for hiding a target jump link, and
determine a target invisible string as a hidden tag based on a type of the target carrier, the target invisible string comprising a plurality of preset invisible characters with zero display widths, and
a coding module configured to embed codes corresponding to the target invisible string into codes of text of an original page.

15. The device of claim 14, wherein the plurality of components further comprise an identifying module configured to:
receive the target carrier from a client terminal,
determine the target jump link corresponding to the target carrier based on a preset matching rule, and
transmit the target jump link to the client terminal to cause the client terminal to load a corresponding target page based on the target jump link.

16. The device of claim 15, wherein the plurality of components further comprise a rule managing module configured to:
store a correlation between the target invisible string and the target jump link as a first matching rule if the type of the carrier is an invisible string type, and
store a correlation between a visible text of the carrier and the target jump link as a second matching rule if the type of the carrier is a visible text type.

17. The device of claim 16, wherein the identifying module determines the target jump link corresponding to the target carrier based on the preset matching rule by:
determining the target jump link based on the first matching rule if the type of the carrier is the invisible string type; and
determining the target jump link based on the second matching rule If the type of the carrier is the visible text type.

18. The device of claim 14, wherein the hiding configuration module determines the target invisible string as the hidden tag based on the type of the carrier by determining a characteristics string corresponding to the target jump link and designating the characteristics string as the target invisible string if the type of the carrier is an invisible string type.

19. The device of claim 14, wherein the hiding configuration module determines the target invisible string as the hidden tag based on the type of the carrier by obtaining a predetermined tag string as the target invisible string If the type of the carrier is a visible text type.

20. The device of claim 14, wherein the coding module embeds the codes corresponding to the target invisible string into the codes of text of the original page by embedding a portion or all of the codes corresponding to the target invisible string before and/or after the codes of text of the original page.
